(19) United States
(12) Patent Application Publication
(10) Pub. No.: US 2020/0246919 A1
(43) Pub. Date: Aug. 6, 2020

(54) LASER CUTTING METHOD

(71) Applicant: Laser Mechanisms Taiwan Ltd., Taipei City (TW)

(72) Inventors: Po-Ting CHEN, Taipei City (TW); Cheng-Hsiang LIN, Taipei City (TW)

(73) Assignee: Laser Mechanisms Taiwan Ltd., Taipei City (TW)

(21) Appl. No.: 16/751,191

(22) Filed: Jan. 23, 2020

(30) Foreign Application Priority Data
Jan. 31, 2019 (TW) 108103963

(51) Int. Cl. B23K 26/38; B23K 26/16; B23K 26/082; B23K 26/60; B23K 26/08; B23K 37/04

(52) U.S. Cl. CPC B23K 26/38; B23K 26/16; B23K 37/0408; B23K 26/60; B23K 26/083; B23K 26/082

(57) ABSTRACT

A laser cutting method of the present invention comprises the steps below: a feeding mechanism generating movement information by driving the workpiece to move, and transmitting the movement information to a computing mechanism; transmitting a cutting path to the computing mechanism, making the computing mechanism calculate the cutting path and the movement information to generate a compensation cutting path, and transmitting the compensation cutting path to a fixed laser cutting mechanism; by a laser cutting mechanism, projecting a laser beam onto a moving workpiece, and continuously changing the projection direction of the laser beam onto the workpiece according to the compensation cutting path, so that the workpiece is cut by the laser beam to form a target pattern. Whereby, when the laser cutting mechanism performs laser cutting on the workpiece, the workpiece still moves without stopping, thereby shortening the processing time and relatively improving production efficiency.

### FIELD OF THE DISCLOSURE

The present disclosure relates to a laser cutting method, and more particularly, to a method capable of performing laser cutting on a moving workpiece.

### BACKGROUND

Laser processing is to output a high-power laser beam by focusing from an optical system and to project the laser beam onto the workpiece, so that the laser beam performs laser beam machining on the workpiece, such as marking, dicing, scribing, and grooving and the like.

However, at present, when performing the laser beam machining operation, the feeding mechanism needs to move a workpiece to a preset position, and then the cutting head of the laser cutting mechanism projects the laser beam onto the workpiece; in addition, the cutting head of the laser cutting mechanism moves according to a cutting path, so that the laser beam machines the stationary workpiece forms the target pattern. Furthermore, after the target pattern is completed, the feeding mechanism moves the target pattern away from the laser cutting mechanism. In this way, laser beam machining for each workpiece must go through the process of stopping and moving, and thus it will take a longer working time to complete the target pattern, relatively reducing the production efficiency.

### SUMMARY

The main purpose of the present invention is that the laser cutting mechanism can continuously project a laser beam onto a workpiece, so that the laser beam continuously performs laser cutting on the workpiece, and the workpiece can form a large number of target patterns in a short time, further to improve the efficiency of producing target pattern.

To achieve above purpose, in one preferred embodiment, a laser cutting method of the present invention comprises: a feeding setting step, a path planning step and a laser cutting step. In addition, the laser cutting method of the present invention allows a laser cutting mechanism with a fixed position to perform laser cutting on a moving workpiece to form a target pattern.

The feeding setting method comprises: a feeding mechanism drives the workpiece to move at a moving speed, and the feeding mechanism generates movement information corresponding to the moving speed and transmits the movement information to a computing mechanism; the path planning step comprises: a cutting path generated from the target pattern is provided to the computing mechanism, and the computing mechanism performs calculation on the cutting path and the movement information to generate a compensation cutting path, and transmits the compensation cutting path to the laser cutting mechanism;

A laser cutting step comprises: the laser cutting mechanism projects a laser beam onto the workpiece that is moving at the moving speed, and the laser cutting mechanism continuously changes the projection direction of the laser beam projecting onto the workpiece according to the compensation cutting path, so that the workpiece is cut by the laser beam to form the target pattern.

In the present embodiment, the feeding setting step further comprises: when the feeding mechanism drives the workpiece to move, a plastic film is synchronously moved by the feeding mechanism for attaching to the bottom surface of the workpiece; the laser cutting step further includes a scrap removing step which comprises: the plastic film is separated from the workpiece, so that the plastic film together with the scrap formed by cutting the workpiece by the laser beam are separated from the target pattern. Wherein the laser cutting method further comprises an object positioning step before the scrap removing step, and the object positioning step comprises: a positioning film is attached to the top surface of the workpiece in a state where the workpiece is moving, so that when the scrap removing step is being performed, the positioning film is still attached to the target pattern, and thus the form of the target pattern can be retained.

In another one preferred embodiment, the laser cutting method of the present invention comprises: a feeding setting step, a path planning step, a time compensation step, a laser cutting step, and a laser re-cutting step. In addition, according to the laser cutting method of the present invention, a fixed laser cutting mechanism and a fixed auxiliary laser cutting mechanism sequentially perform laser cutting on a moving workpiece to form a target pattern.

The feeding setting step comprises: a feeding mechanism drives the workpiece to move at a moving speed, and the feeding mechanism generates movement information corresponding to the moving speed and transmits the movement information to a computing mechanism; the path planning step comprises: a cutting path and the movement information generated by the target pattern are provided to the computing mechanism, the computing mechanism performs calculation on the cutting path and the movement information to generate a compensation cutting path and an auxiliary compensation cutting path, and the computing mechanism transmits the compensation cutting path to the laser cutting mechanism, and then transmits the auxiliary compensation cutting path to the auxiliary laser cutting mechanism; the time compensation step comprises: distance information indicating the distance between the laser cutting mechanism and the auxiliary laser cutting mechanism is provided to the computing mechanism, and the computing mechanism performs calculation on the movement information and the distance information to generate a delay information, and transmits the delay information to the auxiliary laser cutting mechanism.

The laser cutting step comprises: the laser cutting mechanism first projects a laser beam onto the workpiece that is moving at the moving speed, and continuously changes the projection direction of the laser beam projecting onto the workpiece through the compensation cutting path, so that the workpiece is cut by the laser beam to form a semi-finished object; finally the laser re-cutting step comprises: the auxiliary laser cutting mechanism projects an auxiliary laser beam onto the semi-finished object through the delay information after completing the laser cutting step, and continuously changes the projection direction of auxiliary laser beam projecting onto the semi-finished object through the auxiliary compensation cutting path, so that the semi-finished object is cut by the auxiliary laser beam to form the target pattern.

In the present embodiment, the computing mechanism divides the cutting path into at least two path sections with different routes according to the moving direction of the workpiece, and the computing mechanism reduces the path section through the movement information to form the compensation cutting path and the auxiliary compensation cutting path.

Moreover, the laser cutting mechanism and the auxiliary laser cutting mechanism are separately arranged with a laser head and a projection source inside the laser head, wherein the two projection sources each can selectively move close to or away from the workpiece, so that the projection sources can synchronously move toward the workpiece.

Wherein, the feeding setting step further comprises: when the feeding mechanism drives the workpiece to move, a plastic film is synchronously moved by the feeding mechanism for attaching to the bottom surface of the workpiece. In addition, the laser re-cutting step is further followed by a scrap removing step, comprising: the plastic film is separated from the workpiece, so that the plastic film together with scrap formed by cutting the workpiece with the laser beam are separated from the target pattern.

Wherein, the laser cutting method further comprises an object positioning step before the scrap removing step, which comprises: a positioning film is attached to the top surface of the workpiece in a state where the workpiece is moving, so that when the scrap removing step is being performed, the positioning film is still attached to the target pattern, and thus the form of the target pattern can be retained.

In the previous two embodiments, the projection path of the laser beam is arranged with a fixed focusing lens and two reflectors capable of swinging. In addition, one of the reflectors swings along a first direction and the other swings along a second direction different from the first direction.

Moreover, the laser cutting method further includes a removing step, an adsorption step, and a tension adjustment step. The removing step comprises: a blower generates an airflow, the airflow flows toward the workpiece being cut by the laser beam, and a suction mechanism sucks the airflow, and thus a plurality of debris formed by cutting the workpiece with the laser beam is guided by the airflow to be removed.

The adsorption step comprises: an adsorption mechanism generates an adsorption airflow on the moving workpiece, and the workpiece retains a planar form through the adsorption airflow during the movement. The tension adjustment step comprises: two tension rollers are provided, and the two tension rollers are separately wounded with a part of the workpiece, such that the two tension rollers jointly tighten the workpiece.

The present invention is characterized in that when the laser cutting mechanism performs laser machining on a workpiece, the laser cutting mechanism continuously change the projection direction of the laser beam projecting onto the workpiece according to the compensation cutting path, so that the laser beam can perform laser cutting on the moving workpiece to form target pattern; furthermore, during the laser cutting operation of the workpiece, the feeding mechanism will continuously drive the workpiece to move without stopping, and simultaneously the laser cutting mechanism continuously project the laser beam onto the workpiece, so that the workpiece forms a large number of target patterns in a short time, thereby improving the efficiency of producing target pattern.

### BRIEF DESCRIPTION OF THE DRAWINGS

FIG. 1 is a schematic illustrating flowchart of the laser cutting method according to a first preferred embodiment;

FIG. 2A is a schematic illustrating laser cutting table according to a first preferred embodiment;

FIG. 2B is a schematic illustrating the laser cutting mechanism;

FIG. 3 is a schematic illustrating the tension adjustment step in FIG. 1;

FIG. 4 is a schematic illustrating the feeding setting step in FIG. 1;

FIG. 5 is a schematic illustrating the adsorption step in FIG. 1;

FIG. 6 is a schematic illustrating the path planning step in FIG. 1;

FIGS. 7A and 7B are schematic illustrating the laser cutting step in FIG. 1;

FIG. 8 is a schematic illustrating the removing step in FIG. 1;

FIG. 9 is a schematic illustrating the object positioning step in FIG. 1;

FIG. 10 is a schematic illustrating the scrap removing step in FIG. 1;

FIG. 11 is a schematic the laser cutting method according to a second preferred embodiment;

FIG. 12 is a schematic the laser cutting table according to the second preferred embodiment;

FIG. 13 is a schematic illustrating the path planning step in FIG. 11;

FIG. 14 is a schematic illustrating the time compensation step in FIG. 11; and

FIGS. 15A and 15B are schematic illustrating the laser cutting step and the laser re-cutting step in FIG. 11.

### DETAILED DESCRIPTION OF PREFERRED EMBODIMENTS

In order to further understand the structure, usage and features of the present invention more clearly, the present invention is described in detail below with references to the accompanying drawings and specific preferred embodiments:

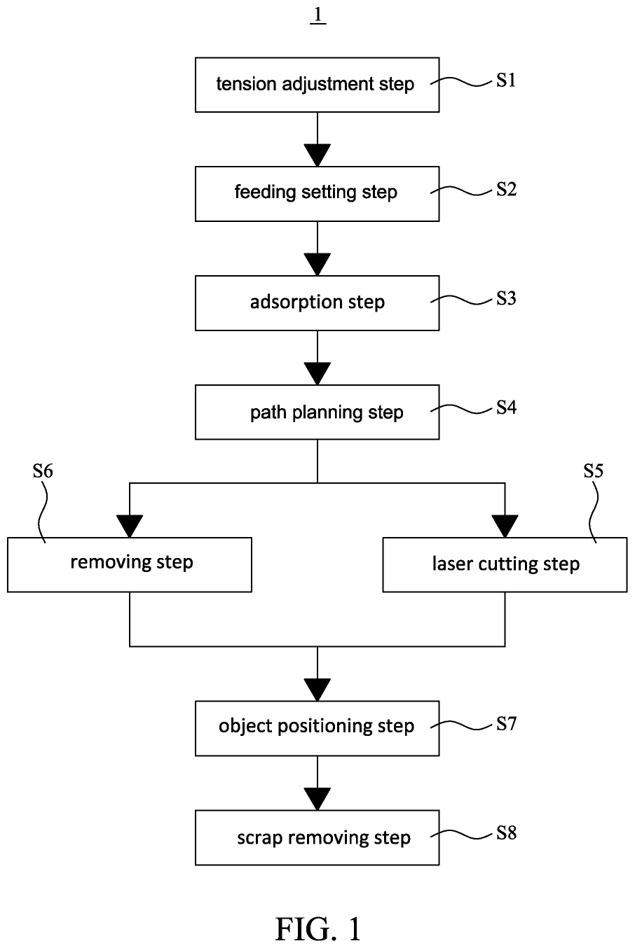

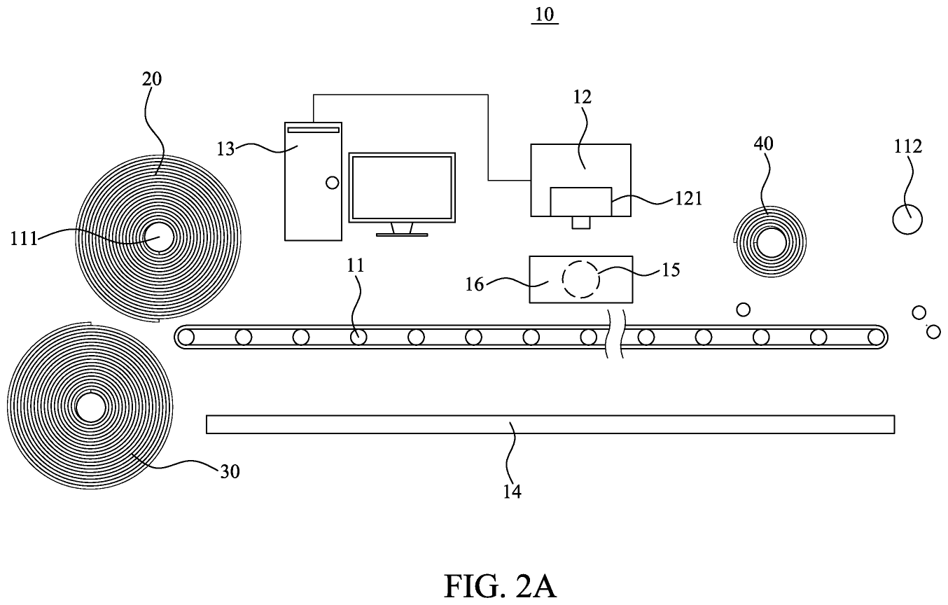

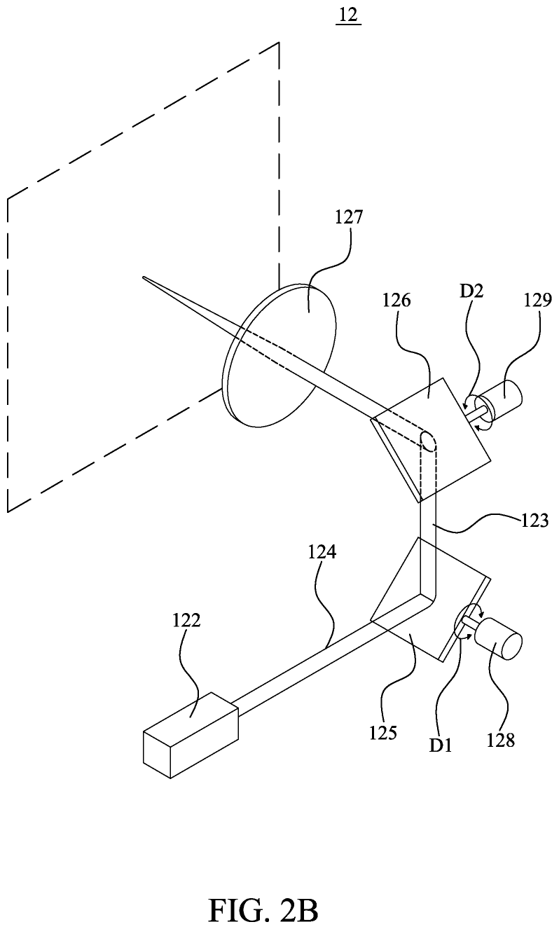

Please refer to FIGS. 1 and 2A. In a first preferred embodiment, the laser cutting method 1 of the present invention is used in conjunction with a laser cutting table 10. As shown in FIG. 2A, the laser cutting table 10 includes a feeding mechanism 11, a laser cutting mechanism 12, a computing mechanism 13, an adsorption mechanism 14, a blower 15 and a suction mechanism 16. The feeding mechanism 11 can drive an object to move, and has a first tension roller 111 and a second tension roller 112 spaced apart from the first tension roller 111. The laser cutting mechanism 12 is stationary so that the position of the laser cutting mechanism 12 is fixed. Moreover, the laser cutting mechanism 12 has a movable laser head 121, a projection source 122 is arranged inside the laser head 121, and the projection source 122 can project a laser beam 123 to form a projection path 124. As shown in FIG. 2B, the projection path 124 is arranged with a first reflector 125, a second reflector 126, and a focusing lens 127. In the present embodiment, the first reflector 125 is assembled with a first swing driving source 128 and is driven by the first swing driving source 128 to swing in a first direction D1; the second reflector 126 is assembled with a second swing driving source 129, and can be driven by the second swing driving source 129 to swing in a direction D2 which is different from the direction D1. Furthermore, the focusing lens 127 is stationary and makes the laser beam 123 continuously focus on a certain point. In addition, the computing mechanism 13 is electrically connected to the laser cutting mechanism 12 and the adsorption mechanism 14 is located below the feeding mechanism 11. The blower 15 and the suction mechanism 16 are located on the front and rear sides of the feeding mechanism 11 respectively.

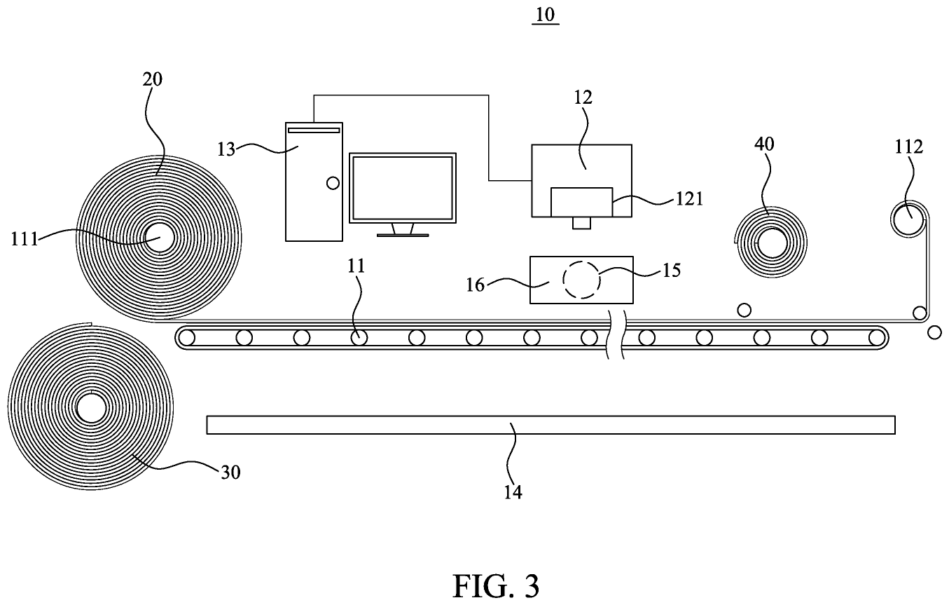

Please refer to FIGS. 1 and 3. In practical application of the laser cutting table 10, a workpiece 20 of longer length than the feeding mechanism 11 is wounded around the first tension roller 111 of the feeding mechanism 11 and the second tension roller 112 of the feeding mechanism 11, making the first and second tension rollers 111,112 jointly tighten the workpiece 20 to complete a tension adjustment step S1. In the present embodiment, the workpiece 20 is a metal material, and the thickness of the workpiece 20 is less than 1 mm.

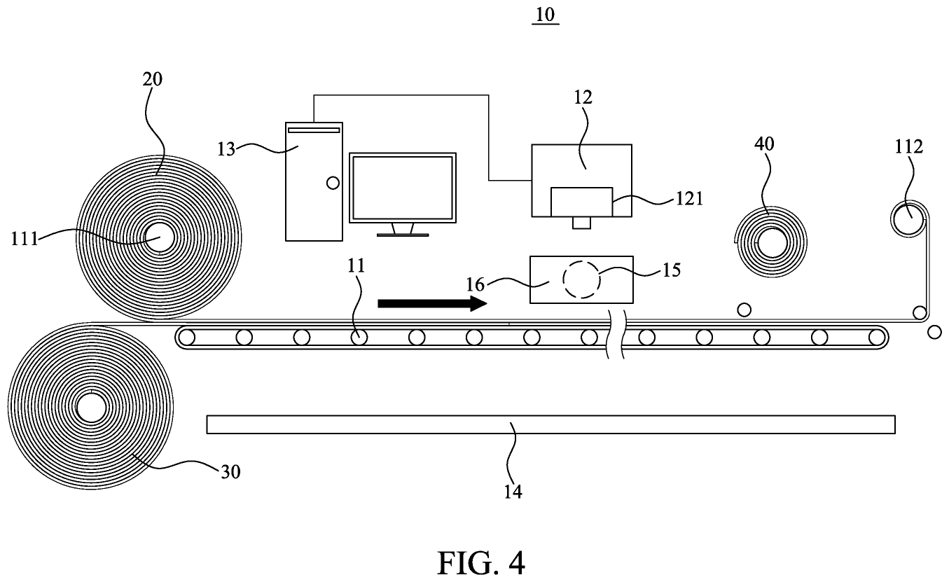

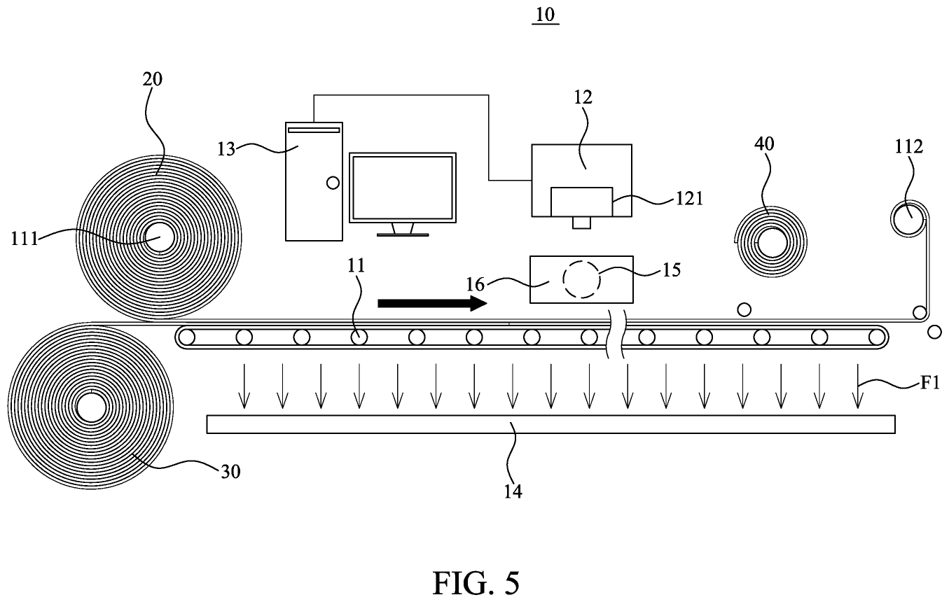

Please refer to FIGS. 1 and 4. After the tension adjustment step S1 is completed, the feeding mechanism 11 drives the workpiece 20 to move at a moving speed. When the feeding mechanism 11 drives the workpiece 20 to move, the feeding mechanism 11 generates movement information corresponding to the moving speed, and transmits the movement information to the computing mechanism 13, whereby a feeding setting step S2 is completed. Wherein, when performing the feeding setting step S2, the feeding mechanism 11 drives the workpiece 20 to move, furthermore the feeding mechanism 11 synchronously drives a plastic film 30 to move, so that the plastic film 30 is attached to the bottom surface of the workpiece 20. In the present embodiment, the movement information indicates how far the workpiece 20 can move in a unit time (for example, 10 m/min). Please refer to FIG. 1 and FIG. 5, when the feeding mechanism 11 drives the processing object 20 to move, the adsorption mechanism 14 generates an adsorption airflow F1 flowing from top to bottom, and the processing object 20 passes through the adsorption airflow during the movement. F1 is in close contact with the feeding mechanism 11 to keep the workpiece 20 flat and complete an adsorption step S3.

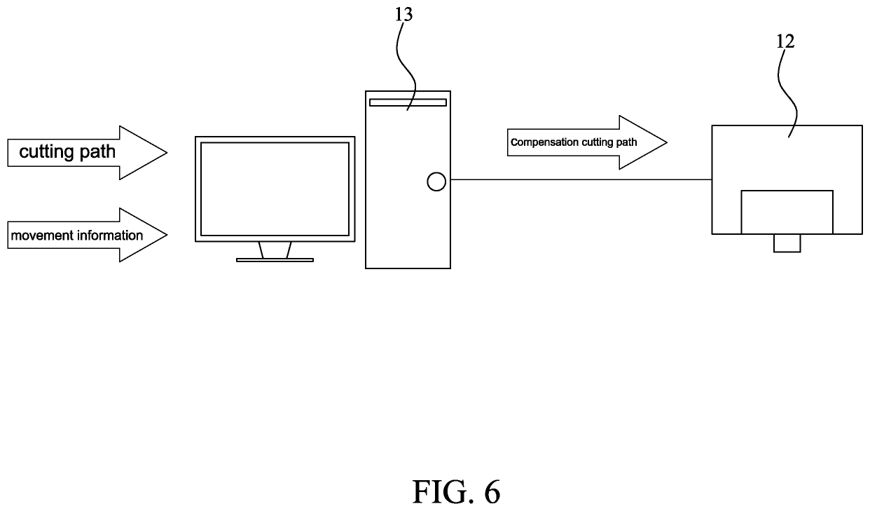

Please refer to FIGS. 1 and 6. After completing the feeding setting step S2, a path planning step S4 is performed. A cutting path capable of producing a cutting pattern is input into the computing mechanism 13. The computing mechanism 13 performs calculation on the cutting path according to the movement information to compress the size of the cutting pattern, and thus the computing mechanism 13 generates a compensation cutting path, and then the computing mechanism 13 transmits the compensation cutting path to the laser cutting mechanism 12.

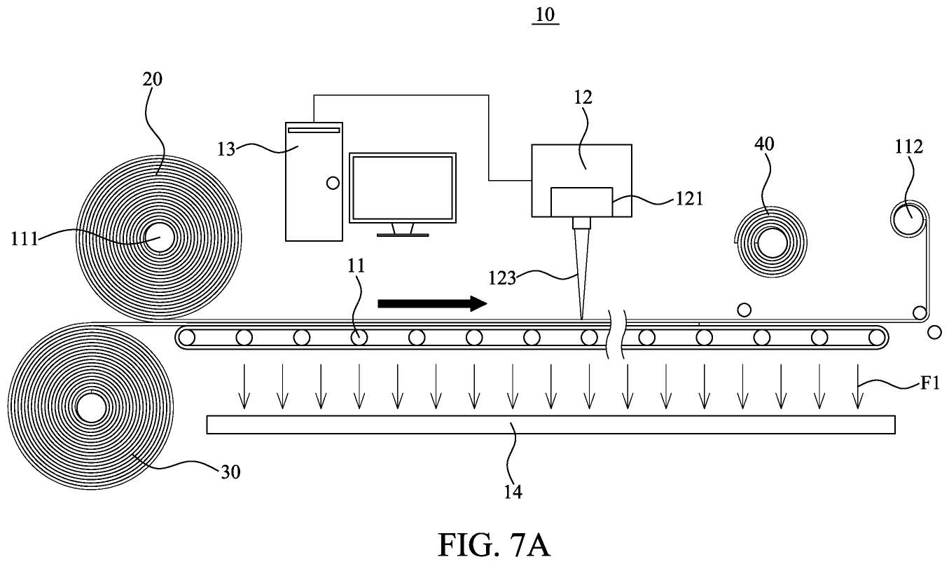

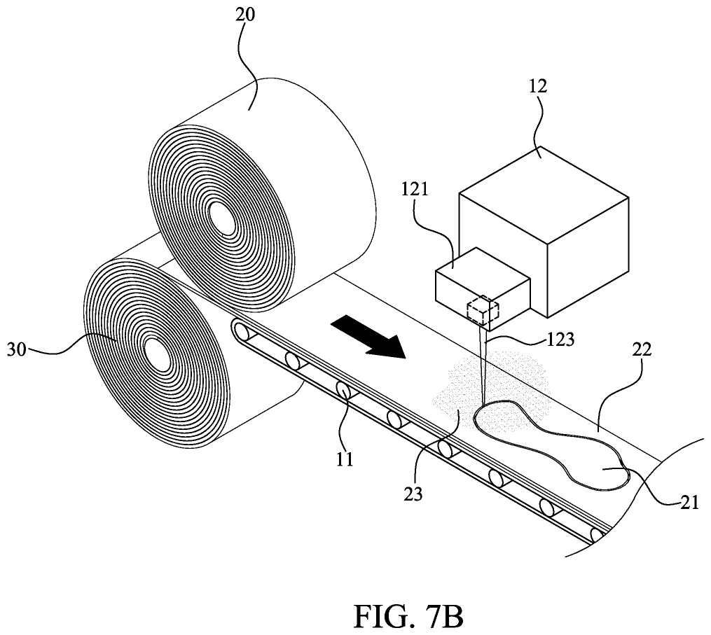

Please refer to FIGS. 1, 7A and 7B. When the laser cutting mechanism 12 receives the compensation cutting path, a laser cutting step S5 starts. The projection source 122 of the laser cutting mechanism 12 continuously projects the laser beam 123. The laser beam 123 sequentially passes the first reflector 125, the second reflector 126, the focusing lens 127, and the workpiece 20 to form a projection path 124. In addition, the laser cutting mechanism 12 controls the first and second swing driving sources 128, 129 according to the compensation cutting path, allowing the first and second swing driving sources 128, 129 to drive the first and second reflectors 125, 126 to respectively swing along the first and second directions D1, D2 to change the projection direction of the laser beam 123 projecting onto the workpiece 20; such that when the projection direction of the laser beam 123 onto the workpiece 20 changes, the laser beam 123 can continuously focus on the workpiece 20 via the focusing lens 127. Through it, in the case where the feeding mechanism 11 drives the workpiece 20 to move, the laser cutting mechanism 12 changes the projection direction of the laser beam 123 onto the workpiece 20 according to the compensation cutting path, so that the laser beam 123 continuously cuts the workpiece 20, and thus a part of the workpiece 20 forms a target pattern 21 corresponding to the cutting pattern, while the remaining part of the workpiece 20 forms a scrap 22. Furthermore, when the laser beam 123 cuts the workpiece 20, the workpiece 20 will generates debris 23. Wherein, the laser beam 123 will only cut through the workpiece 20 and will not cut through the plastic film 30.

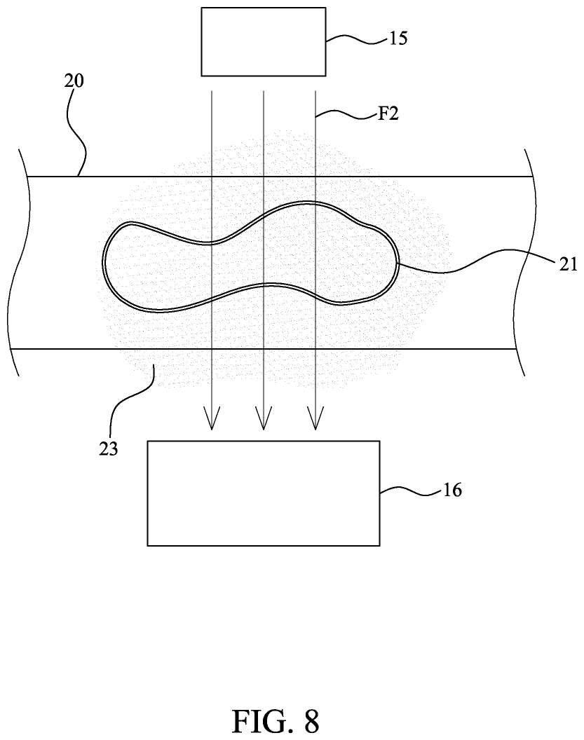

Please refer to FIGS. 1 and 8. When performing the laser cutting step S5, a removing step S6 is simultaneously being performed. During the removing step S6, the blower 15 generates airflow F2, and the airflow F2 flows toward the workpiece 20 which is being cut by the laser beam 123, such that the airflow F2 entrains the debris 23 toward the suction mechanism 16; the suction mechanism 16 sucks the airflow F2, so that the debris 23 guided by the airflow F2 is removed, so as to prevent the debris 23 from scattering around the environment.

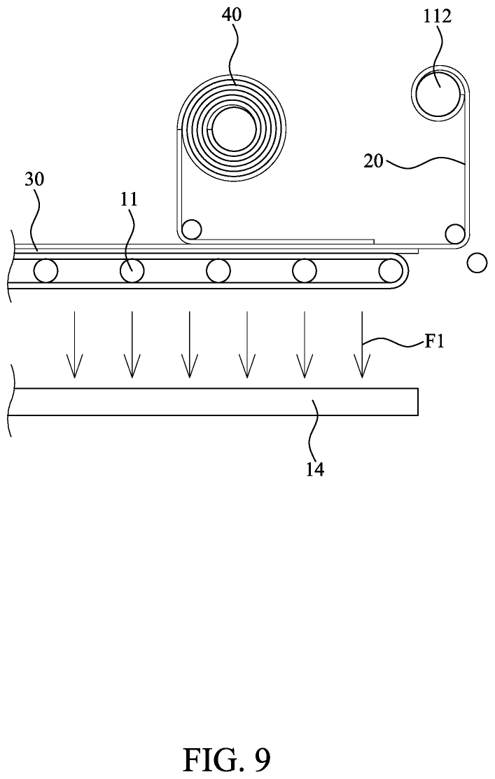

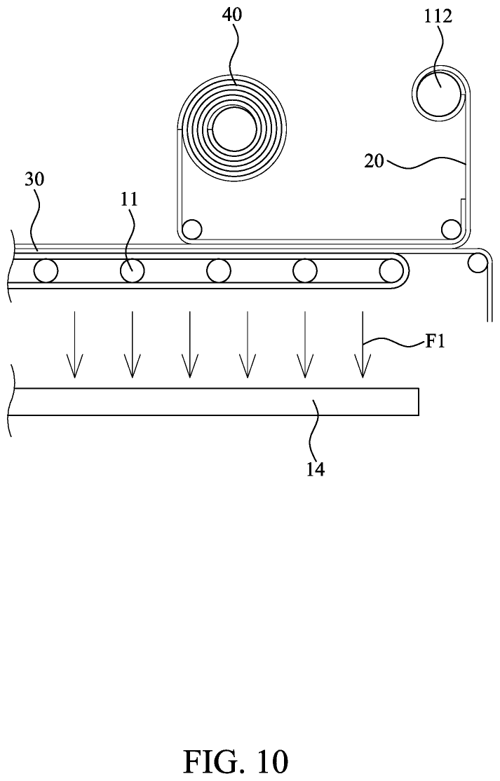

Please refer to FIGS. 1 and 9. After completing the laser cutting step S5, an object positioning step S7 is performed. In a state where the feeding mechanism 11 drives the workpiece 20 to move, a positioning film 40 is attached to the top surface of the workpiece 20 so that the positioning film 40 is simultaneously attached to the target pattern 21 and the scrap 22. Please refer to FIGS. 1 and 10. After completing the object positioning step S7, a scrap removing step S8 is performed. The plastic film 30 is separated from the workpiece 20, so that the scrap 22 with the plastic film 30 are both separated from the target pattern 21, while the positioning film 40 is still attached to the target pattern 21, thereby retaining the shape of the target pattern 21.

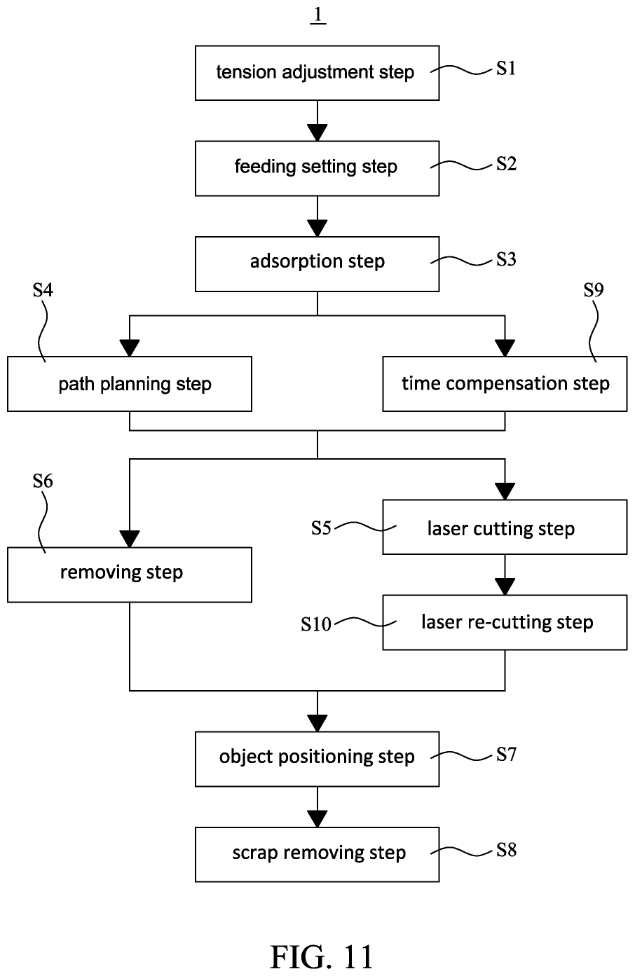

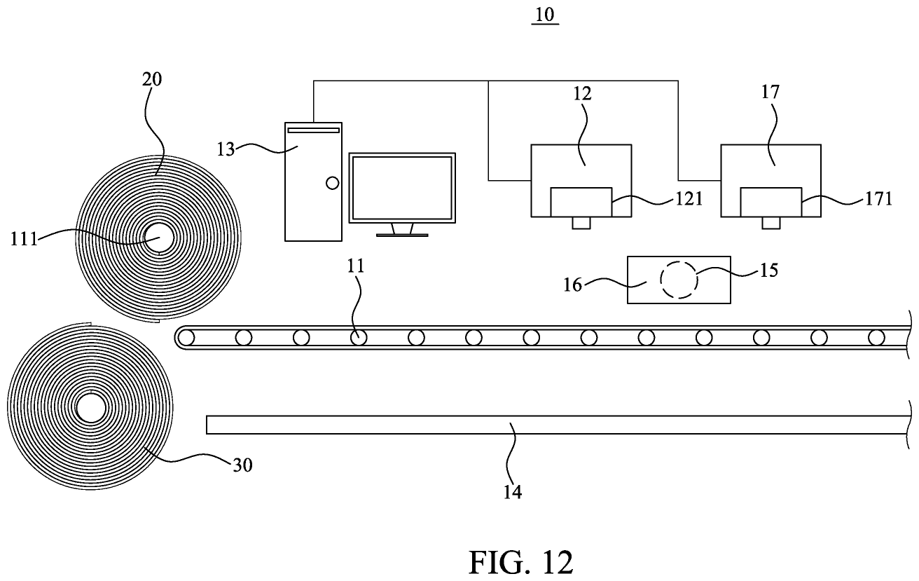

Please refer to FIGS. 11 and 12. In a second preferred embodiment, the laser cutting method 1 of the present invention further includes a time compensation step S9 and a laser re-cutting step S10. In addition, the laser cutting table 10 further has an auxiliary laser cutting mechanism 17 with the same structural composition as the laser cutting mechanism 12, and the auxiliary laser cutting mechanism 17 is spaced apart from the laser cutting mechanism 12. Both the laser head 121 of the laser cutting mechanism 12 and the laser head 171 of the auxiliary laser cutting mechanism 17 can separately move toward the feeding mechanism 11, so that the projection source 122 can move close to or away from the feeding mechanism 11 synchronously; wherein, the structure of the feeding mechanism 11, the laser cutting mechanism 12, and the computing mechanism 13 is the same as the first preferred embodiment; accordingly, the structures of the feeding mechanism 11, the laser cutting mechanism 12, and the computing mechanism 13 would not be repeated herein again.

In the present embodiment, when the laser cutting table 10 is in use, the adsorption step S3 and feeding setting step S2 are performed successively. In addition, in the present embodiment, both the adsorption step S3 and the feeding setting step S2 are the same as the first preferred embodiment, such that both the first and second tension rollers 111, 112 jointly tighten the workpiece 20, so that the workpiece 20 retains flat. In addition, the feeding mechanism 11 synchronously drives the workpiece 20 and the plastic film 30 to move.

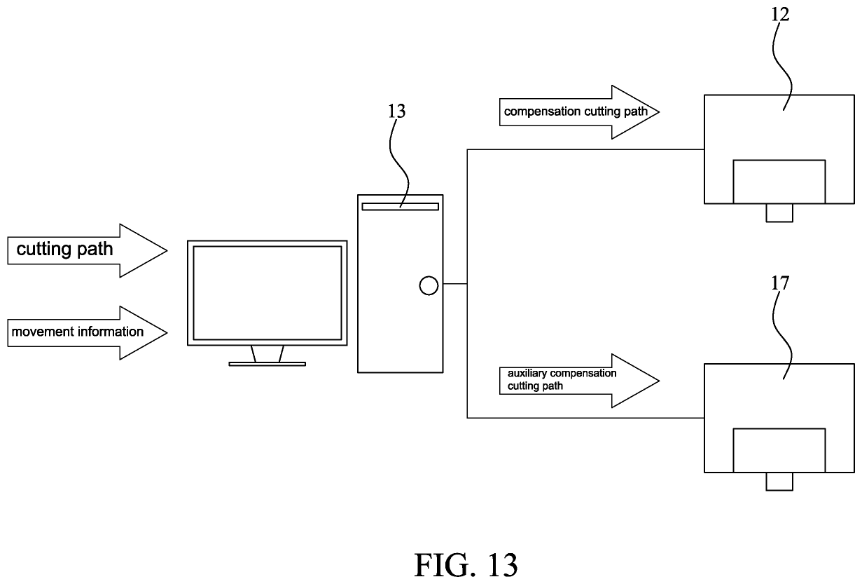

Please refer to FIGS. 11 and 13. After completing the feeding setting step S2, perform the path planning step S4. The cutting path and movement information are input into the computing mechanism 13, and the computing mechanism 13 will perform calculation on the cutting path according to the movement information to compress the size of the cutting pattern, and thus the computing mechanism 13 generates the compensation cutting path and an auxiliary compensation cutting path with form different from the compensation cutting path; wherein, the computing mechanism 13 would transmit the compensation cutting path to the laser cutting mechanism 12, and then transmits the compensation cutting path to the auxiliary laser cutting mechanism 17.

In the present embodiment, when the path planning step S4 is being performed, the computing mechanism 13 would obtain the moving direction of the workpiece 20 (as indicated by the arrow in the figure), and divides the cutting path into two path sections having different forms according to the moving direction of the workpiece 20. The computing mechanism 13 performs calculation on each the path section through the movement information, so that the path length of each the path section reduces through the movement information, and thus each the path section is converted to form the compensation cutting path and the auxiliary compensation cutting path.

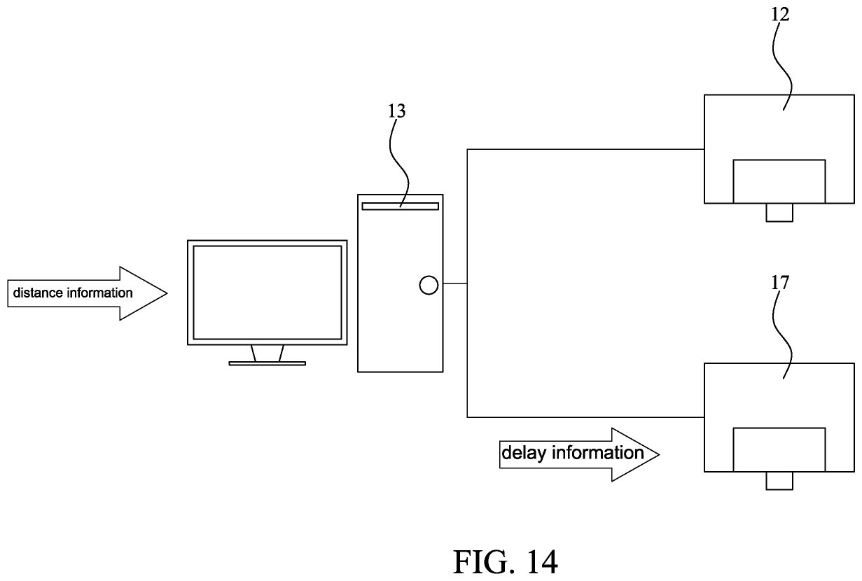

Please refer to FIGS. 11 and 14. During the path planning step S4, the time compensation step S9 can be performed simultaneously. Distance information indicating the distance between the laser cutting mechanism 12 and the auxiliary laser cutting mechanism 17 is provided to the computing mechanism 13; the computing mechanism 13 performs calculation on the distance information and the movement information to generate delay information, and then transmits the delay information to the auxiliary laser cutting mechanism 17 to complete the time compensation step S9.

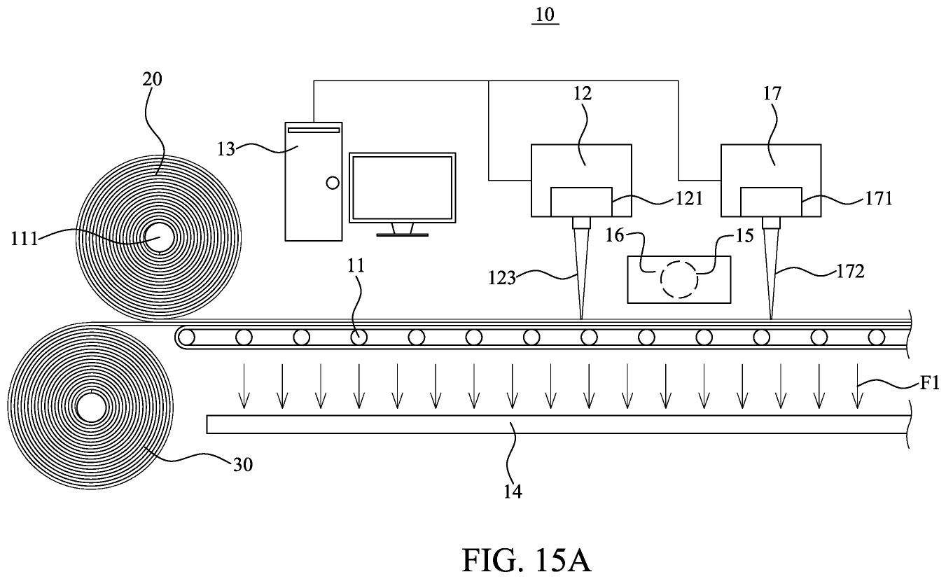

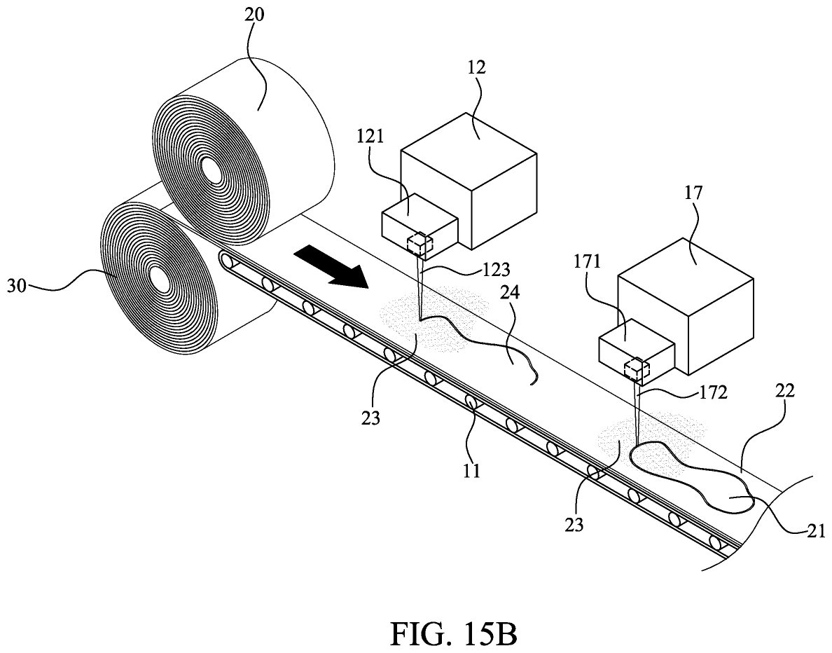

Please refer to FIGS. 11, 15A and 15B. Subsequently, perform the laser cutting method S5. When the laser cutting mechanism 12 receives the compensation cutting path, the projection source 122 of the laser cutting mechanism 12 first projects the laser beam 123 onto the workpiece 20, and the laser cutting mechanism 12 also controls the first and second swing driving sources 128, 129 and moving driving source to operate, so that the first and second reflector 125, 126 respectively swing along the first and second direction D1, D2 to change projection direction of the laser beam 123 projecting onto the workpiece 20; thus the focusing lens 127 can move close to or away from the workpiece 20, and the laser beam 123 can continuously focus on the workpiece 20 via the focusing lens 127 when the projection direction of the laser beam 123 onto the workpiece 20 changes; whereby in the case where the feeding mechanism 11 drives the workpiece 20 to move, the laser cutting mechanism 12 changes the projection direction of the laser beam 123 through the compensation cutting path, so that the workpiece 20 is cut by the laser beam 123 to form a semi-finished object 24.

After completing the laser cutting step S5, perform the laser re-cutting step S10. As shown in the figure, the auxiliary laser cutting mechanism 17 delays projecting an auxiliary laser beam 172 through the delay information after the laser cutting step S5 is completed, and the auxiliary laser beam 172 projects onto the semi-finished object 24. At the same time, the semi-finished article 24 is moving at the moving speed, and the auxiliary laser cutting mechanism 17 continuously changes the projection direction of the auxiliary laser beam 172 projecting onto the semi-finished article 24 through the auxiliary compensation cutting path, so that the auxiliary laser beam 172 cuts the semi-finished product 24 to form the target pattern 21.

When the laser cutting step S5 and the laser re-cutting step S10 are being performed, the removing step S6 is being performed at the same time, so that debris 23 is guided by the airflow F2 to be removed. In addition, after the laser cutting step S5 is completed, the object positioning step S7 and the scrap removing step S8 are sequentially performed as in the first preferred embodiment.

The above-instanced embodiments are used for conveniently describing the present invention, not further to limit it. For the person skilled in the art of the disclosure, without departing from the concept of the disclosure, simple modifications or changes can be made and should be included in the claims and their equivalents of the present application.

What is claimed is:

1. A laser cutting method, allowing a laser cutting mechanism with a fixed position to perform laser cutting on a moving workpiece for forming a target pattern, the method comprising
a feeding setting step, where a feeding mechanism drives the workpiece to move at a moving speed, wherein the feeding mechanism generates movement information corresponding to the moving speed and transmits the movement information to a computing mechanism;
a path planning step, where a cutting path generated from the target pattern is provided to the computing mechanism, wherein the computing mechanism performs calculation on the cutting path and the movement information to generate a compensation cutting path, and transmits the compensation cutting path to the laser cutting mechanism; and
a laser cutting step, where the laser cutting mechanism projects a laser beam onto the workpiece that is moving at the moving speed, wherein the laser cutting mechanism continuously changes the projection direction of the laser beam projecting onto the workpiece according to the compensation cutting path, so that the workpiece is cut by the laser beam to form the target pattern.

2. The laser cutting method according to claim 1, wherein the laser cutting mechanism is arranged with two reflectors capable of swinging and a fixed focusing lens, and wherein the laser light sequentially passes the two reflectors and the focusing lens, and one of the reflectors swings along a first direction, while the other swings along a second direction different from the first direction.

3. The laser cutting method according to claim 1, wherein the method further comprise a removing step, where a blower generates a airflow, and the airflow flows toward the workpiece being cut by the laser beam, wherein a suction mechanism sucks the airflow, and thus debris formed by cutting the workpiece with the laser beam is guided by the airflow to be removed.

4. The laser cutting method according to claim 1, wherein the method further comprise a adsorption step, where an adsorption mechanism generates an adsorption airflow on the moving workpiece, and the workpiece retains a planar form.

5. The laser cutting method according to claim 1, wherein the method further comprise a tension adjustment step, where two tension rollers are provided, and the two tension rollers are separately wound with a part of the workpiece, such that the two tension rollers jointly tighten the workpiece.

6. The laser cutting method according to claim 1, wherein the feeding setting step further comprises, where when the feeding mechanism drives the workpiece to move, a plastic film is synchronously moved by the feeding mechanism for attaching to the bottom surface of the workpiece; and
wherein the laser cutting step is further followed by a scrap removing step, where the plastic film is separated from the workpiece, so that the plastic film together with scrap formed by cutting the workpiece through the laser beam are separated from the target pattern.

7. The laser cutting method according to claim 1, wherein the laser cutting method further comprises an object positioning step before the scrap removing step, of which a positioning film is attached to the top surface of the workpiece in a state where the workpiece is moving, so that when the scrap removing step is being performed, the positioning film is still attached to the target pattern, and thus the form of the target pattern can be retained.

8. A laser cutting method, allowing a laser cutting mechanism with a fixed position and a fixed auxiliary laser cutting mechanism with a fixed position sequentially perform laser cutting on a moving workpiece to form a target pattern, the method comprising
a feeding setting step, where a feeding mechanism drives the workpiece to move at a moving speed, wherein the feeding mechanism generates movement information corresponding to the moving speed and transmits the movement information to a computing mechanism;
a path planning step, where a cutting path and the movement information generated by the target pattern are provided to the computing mechanism, the computing mechanism performs calculation on the cutting path and the movement information to generate a compensation cutting path and an auxiliary compensation cutting path, and the computing mechanism transmits the compensation cutting path to the laser cutting mechanism, and then transmits the auxiliary compensation cutting path to the auxiliary laser cutting mechanism;
a time compensation step, where distance information indicating the distance between the laser cutting mechanism and the auxiliary laser cutting mechanism is provided to the computing mechanism, wherein the computing mechanism performs calculation on the movement information and the distance information to generate delay information, and transmits the delay information to the auxiliary laser cutting mechanism;
a laser cutting step, where the laser cutting mechanism first projects a laser beam onto the workpiece that is moving at the moving speed, and continuously changes the projection direction of the laser beam projecting onto the workpiece through the compensation cutting path, so that the workpiece is cut by the laser beam to form a semi-finished object; and
a laser re-cutting step, where the auxiliary laser cutting mechanism projects an auxiliary laser beam onto the semi-finished object through the delay information after completing the laser cutting step, and continuously changes the projection direction of auxiliary laser beam projecting onto the semi-finished object through the auxiliary compensation cutting path, so that the semi-finished object is cut by the auxiliary laser beam to form the target pattern.

9. The laser cutting method according to claim 8, wherein the projection path of the laser beam is arranged with a fixed focusing lens and two reflectors capable of swinging, and wherein one of the reflectors swings along a first direction and the other swings along a second direction different from the first direction.

10. The laser cutting method according to claim 8, wherein in the path planning step, the computing mechanism divides the cutting path into at least two path sections with different routes according to the moving direction of the workpiece, and the computing mechanism reduces the path section through the movement information to form the compensation cutting path and the auxiliary compensation cutting path.

11. The laser cutting method according to claim 8, wherein the method further comprise a removing step, where a blower generates a airflow, and the airflow flows toward the workpiece being cut by the laser beam, wherein a suction mechanism sucks the airflow, and thus debris formed by cutting the workpiece with the laser beam is guided by the airflow to be removed.

12. The laser cutting method according to claim 8, wherein the method further comprise a adsorption step, where an adsorption mechanism generates an adsorption airflow on the moving workpiece, and the workpiece retains a planar form.

13. The laser cutting method according to claim 9, wherein the method further comprise a tension adjustment step, where two tension rollers are provided, and the two tension rollers are separately wound with a part of the workpiece, such that the two tension rollers jointly tighten the workpiece.

14. The laser cutting method according to claim 8, wherein the feeding setting step further comprises, where when the feeding mechanism drives the workpiece to move, a plastic film is synchronously moved by the feeding mechanism for attaching to the bottom surface of the workpiece; and
wherein the laser re-cutting step is further followed by a scrap removing step, where the plastic film is separated from the workpiece, so that the plastic film together with scrap formed by cutting the workpiece through the laser beam are separated from the target pattern.

15. The laser cutting method according to claim 14, wherein the laser cutting method further comprises an object positioning step before the scrap removing step, of which a positioning film is attached to the top surface of the workpiece in a state where the workpiece is moving, so that when the scrap removing step is being performed, the positioning film is still attached to the target pattern, and thus the form of the target pattern can be retained.

16. The laser cutting method according to claim 8, wherein the laser cutting mechanism and the auxiliary laser cutting mechanism are separately arranged with a laser head and a projection source inside the laser head, wherein the two projection sources each can selectively move close to or away from the workpiece, so that the projection sources can synchronously move toward the workpiece.
